(19) United States
(12) Patent Application Publication
(10) Pub. No.: US 2022/0413093 A1
(43) Pub. Date: Dec. 29, 2022

(54) MULTI-INPUT MULTI-OUTPUT RADAR AND MOBILE TOOL

(71) Applicant: MICROCREATIVE TECHNOLOGY CO., LTD., Zhuhai (CN)

(72) Inventor: Jun Luo, Zhuhai (CN)

(21) Appl. No.: 17/780,262

(22) PCT Filed: Nov. 26, 2019
(86) PCT No.: PCT/CN2019/121007

§ 371 Date: May 26, 2022

(51) Int. Cl. G01S 7/35

(52) U.S. Cl. CPC G01S 7/354; G01S 13/931

(57) ABSTRACT

A multi-input multi-output radar and a moving tool. The multi-input multi-output radar includes: M transmitting channels, each of which is used for simultaneously and respectively transmitting frequency-modulated continuous wave signals of different frequencies; N receiving channels, each of which includes a receiving antenna and a signal demodulator; the receiving antenna for receiving a frequency-modulated continuous wave signal reflected by an object to be detected, wherein the signal demodulator is connected to the receiving antenna, and the signal demodulator is used for converting the reflected frequency-modulated continuous wave signal into a digital signal; and a digital signal processor for analyzing the digital signal, so as to determine information of said object. The multiple transmitting channels simultaneously transmit the frequency-modulated continuous wave signals of different frequencies.

### TECHNICAL FIELD

The present disclosure relates to the technical field of radars, and in particular to a multi-input multi-output radar and a mobile tool.

### BACKGROUND ART

With the development of science and technology, the popularity of mobile tools (such as automobiles) is higher and higher. Meanwhile, in order to ensure driving safety of the mobile tools, the requirements on the radars are higher and higher.

Currently, the radars in the mobile tools generally implement relevant measurement in a time division multiplexing manner. For example, in the case that the mobile tool is an automobile, the conventional automobile millimeter-wave radar is installed in the automobile, so that the automobile can use the automobile millimeter-wave radar to sense the surrounding environment, and collect data, to identify static and dynamic objects.

In the process of implementing the present disclosure, the inventor found that the following problems exist in the prior art: since the radars in the existing mobile tools generally implement the relevant measurement in the time division multiplexing manner, a plurality of cycles are required to detect whether there is an obstacle around the mobile tool. The above method can be realized if the mobile tool does not move. However, as the mobile tool is in a high-speed moving state in an actual scene, the time division multiplexing method cannot meet the requirement.

### SUMMARY

An objective of embodiments of the present disclosure lies in providing a multi-input multi-output radar and a mobile tool, so as to solve the problem that the time division multiplexing method in the prior art cannot meet the requirement of detecting an object in a high-speed moving state.

In a first aspect, an embodiment of the present disclosure provides a multi-input multi-output radar, wherein the multi-input multi-output radar includes: a digital signal processor, M transmitting channels, and N receiving channels, each transmitting channel of the M transmitting channels is configured to simultaneously and respectively transmit frequency-modulated continuous wave signals of different frequencies, each receiving channel of the N receiving channels includes a receiving antenna and a signal demodulator, and M and N are both positive integers, wherein the receiving antenna is configured to receive a frequency-modulated continuous wave signal reflected by an object to be detected; and the signal demodulator is connected to the receiving antenna, and the signal demodulator is configured to convert the reflected frequency-modulated continuous wave signal into a digital signal, wherein the digital signal is used to determine information about the object to be detected; and the digital signal processor is configured to parse the digital signal, so as to determine information about the object to be detected.

Therefore, in the embodiments of the present disclosure, each transmitting channel of the M transmitting channels is configured to simultaneously and respectively transmit frequency-modulated continuous wave signals of different frequencies, the signal demodulator in each receiving channel converts the frequency-modulated continuous wave signal reflected by the object to be detected into the digital signal, and the digital signal processor parses the digital signal, so as to determine information about the object to be detected. Thus, the frequency-modulated continuous wave signals of different frequencies are simultaneously transmitted through a plurality of transmitting channels in the embodiments of the present disclosure, and since extra time is not needed, the movement distance of the object to be detected is very small, such that the radar can detect an object moving at a high speed, and the requirements of a user are met.

In a possible embodiment, the signal demodulator includes a first frequency mixer, a broadband analog baseband, and a high-speed analog-digital converter, wherein the first frequency mixer is connected to the receiving antenna, the first frequency mixer is configured to perform frequency mixing on a first local oscillator signal and the reflected frequency-modulated continuous wave signal, so as to obtain a first intermediate frequency signal, wherein the first local oscillator signal is a frequency-modulated continuous wave signal corresponding to a first preset frequency in different frequencies; the broadband analog baseband is connected to the first frequency mixer, and the broadband analog baseband is configured to filter and amplify the first intermediate frequency signal, so as to obtain filtered and amplified first intermediate frequency signal; and the high-speed analog-digital converter is connected to the broadband analog baseband, and the high-speed analog-digital converter is configured to perform analog-digital conversion on the filtered and amplified first intermediate frequency signal, so as to obtain the digital signal.

Therefore, in the embodiments of the present disclosure, the information about the obstacle is determined through the frequency mixer, the broadband analog baseband, and the high-speed analog-digital converter, so that not only the information about the object to be detected can be accurately measured, but also the volume of the radar chip can be reduced to a certain extent.

In a possible embodiment, the signal demodulator includes M first signal demodulation units connected in parallel, and each first signal demodulation unit of the M first signal demodulation units connected in parallel is corresponding to one transmitting channel, wherein each first signal demodulation unit of the M first signal demodulation units connected in parallel is configured to convert the reflected frequency-modulated continuous wave signal into a digital signal of a corresponding transmitting channel.

Therefore, in the embodiments of the present disclosure, the information about the object to be detected is determined through the M first signal demodulation units connected in parallel, so that the information about the object to be detected can be accurately measured.

In a possible embodiment, each first signal demodulation unit of the M first signal demodulation units connected in parallel includes a second frequency mixer, a first narrowband analog baseband, and a first low-speed analog-digital converter, wherein the second frequency mixer is connected to the receiving antenna, the second frequency mixer is configured to perform frequency mixing on a second local oscillator signal and the reflected frequency-modulated continuous wave signal, so as to obtain a second intermediate frequency signal, wherein the second local oscillator signal is a frequency-modulated continuous wave signal corresponding to a second preset frequency in the different frequencies; the first narrowband analog baseband is connected to the second frequency mixer, and the first narrowband analog baseband is configured to filter and amplify the second intermediate frequency signal, so as to obtain the filtered and amplified second intermediate frequency signal; and the first low-speed analog-digital converter is connected to the first narrowband analog baseband, and the first low-speed analog-digital converter is configured to perform analog-digital conversion on the filtered and amplified second intermediate frequency signal, so as to obtain the digital signal of the corresponding transmitting channel.

Therefore, in the embodiments of the present disclosure, the signal demodulation unit is constituted by the second frequency mixer, the first narrowband analog baseband, and the first low-speed analog-digital converter, so as to meet users' different requirements.

In a possible embodiment, the signal demodulator includes M second signal demodulation units connected in series, wherein each second signal demodulation unit of the M second signal demodulation units connected in series is corresponding to one transmitting channel, and wherein each second signal demodulation unit of the M second signal demodulation units connected in series is configured to convert the reflected frequency-modulated continuous wave signal into a digital signal of the corresponding transmitting channel.

Therefore, in the embodiments of the present disclosure, the information about the object to be detected is determined through the M second signal demodulation units connected in series, so that the information about the object to be detected can be accurately measured.

In a possible embodiment, each second signal demodulation unit of the M second signal demodulation units connected in series includes a third frequency mixer, a second narrowband analog baseband, and a second low-speed analog-digital converter.

Therefore, in the embodiments of the present disclosure, the signal demodulation unit is constituted by the third frequency mixer, the second narrowband analog baseband, and the second low-speed analog-digital converter, so as to meet users' different requirements.

In a possible embodiment, each transmitting channel of the M transmitting channels includes a signal modulator, an oscillator, and a transmitting antenna, wherein the signal modulator is configured to generate a modulating signal of a third preset frequency, wherein the third preset frequency is any frequency in the different frequencies; the oscillator is connected to the signal modulator, and the oscillator is configured to generate the repeated modulating signal, so as to generate the frequency-modulated continuous wave signal; and the transmitting antenna is connected to the oscillator, and the transmitting antenna is configured to transmit the frequency-modulated continuous wave signal.

Therefore, in the embodiments of the present disclosure, the transmitting channel is constructed by the signal modulator, the oscillator, and the transmitting antenna, so that the performance of the transmitting channel can be ensured.

In a possible embodiment, each transmitting channel of the M transmitting channels further includes a power amplifier connected to the transmitting antenna and the oscillator, respectively, and the power amplifier is configured to amplify the frequency-modulated continuous wave signal, and send the amplified frequency-modulated continuous wave signal to the transmitting antenna.

Therefore, in the embodiments of the present disclosure, by configuring the power amplifier, the frequency-modulated continuous wave signal can be amplified to a preset power.

In a possible embodiment, each receiving channel of the N receiving channels further includes a low-noise amplifier connected to the receiving antenna and the signal demodulator, respectively, and the low-noise amplifier is configured to perform low-noise amplification on the reflected frequency-modulated continuous wave signal, and send the low-noise-amplified frequency-modulated continuous wave signal to the signal modulator-demodulator.

Therefore, in the embodiments of the present disclosure, the reflected frequency-modulated continuous wave signal is amplified by the low-noise amplifier, so that the reflected frequency-modulated continuous wave signal can be demodulated.

In a second aspect, an embodiment of the present disclosure further provides a mobile tool, including the multi-input multi-output radar of the first aspect or any optional embodiment of the first aspect.

In order to make the above objectives, features, and advantages to be realized in the embodiments of the present disclosure more apparent and understandable, detailed description is made below specifically with reference to preferred embodiments in conjunction with the accompanying drawings.

### BRIEF DESCRIPTION OF DRAWINGS

In order to more clearly illustrate technical solutions of embodiments of the present disclosure, drawings which need to be used in the embodiments of the present disclosure will be introduced briefly below, and it should be understood that the drawings below merely show some embodiments of the present disclosure, therefore, they should not be considered as limitation on the scope, and those ordinarily skilled in the art still could obtain other relevant drawings according to these drawings, without using any inventive efforts.

FIG. 1 shows a structural schematic view of a chip of an automobile radar in the prior art;

FIG. 2 shows a structural schematic view of a multi-input multi-output radar provided in an embodiment of the present disclosure;

FIG. 3 is a schematic diagram showing variation of a frequency-modulated continuous wave signal over time provided in an embodiment of the present disclosure;

FIG. 4 shows a structural schematic view of another multi-input multi-output radar provided in an embodiment of the present disclosure;

FIG. 5 shows a structural schematic view of another multi-input multi-output radar provided in an embodiment of the present disclosure; and

FIG. 6 shows a structural schematic view of a mobile tool provided in an embodiment of the present disclosure.

### DETAILED DESCRIPTION OF EMBODIMENTS

The technical solutions in the embodiments of the present disclosure will be described below in conjunction with drawings in the embodiments of the present disclosure.

It should be noted that similar reference signs and letters represent similar items in the following drawings, therefore, once a certain item is defined in one drawing, it is not needed to be further defined or explained in subsequent drawings. Meanwhile, in the description of the present disclosure, terms such as “first” and “second” are merely used for distinctive description, but should not be construed as indicating or implying importance in the relativity.

With the rapid development of mobile tools, advanced driver assistant systems are becoming more and more popular, and automatic driving is also gradually starting to be industrialized. In the above, whether for the advanced driver assistant systems or for the automatic driving, it is necessary to use the radar in the mobile tools to sense the environment around the mobile tool, and collect data, to identify static and dynamic objects.

For example, in the case that the mobile tool is an automobile, the conventional automobile millimeter-wave radar is widely applied to the advanced driver assistant system of automobiles by virtue of multiple advantages such as a low cost, a long detection distance, and full-day work.

In order to facilitate understanding of the radar in the existing mobile tools, the following description is made by way of specific embodiments.

As shown in FIG. 1, FIG. 1 shows a structural schematic view of a chip of an automobile radar in the prior art. The automobile radar as shown in FIG. 1 includes: a signal modulator, an oscillator, M transmitting channels, N receiving channels, and a digital signal processor. In the above, the signal modulator is connected to the oscillator, the oscillator is connected to each transmitting channel of the M transmitting channels, respectively, and the N receiving channels are connected to the digital signal processor.

As the structure or configuration of each transmitting channel of the M transmitting channels is the same, and the structure or configuration of each receiving channel of the N receiving channels is also the same, relevant content of one transmitting channel and relevant content of one receiving channel are described below.

It should be understood that the remaining transmitting channels are similar to the transmitting channel described below, and differ in that transmitting time of the remaining M−1 transmitting channels and the transmitting channel described below is different, that is, all the M transmitting channels transmit frequency-modulated continuous wave signals sequentially according to time (in other words, the M transmitting channels transmit the frequency-modulated continuous wave signals in a time division multiplexing (TDM for short) manner), and the description will not be repeated hereinafter.

Correspondingly, the remaining receiving channels are similar to the receiving channel described below, and are not repeatedly described hereinafter. For example, frequency mixers in the remaining receiving channels are all connected to the oscillator. For another example, local oscillator signals of the frequency mixers in individual receiving channels are the same, that is, the frequency mixers in the N receiving channels are in co-local-oscillation. For another example, low-speed analog-digital converters in the N receiving channels may all be connected to the digital signal processor.

In the above, each transmitting channel includes a power amplifier and a transmitting antenna, wherein the power amplifier is connected to the oscillator, and the power amplifier is further connected to the transmitting antenna.

Moreover, each receiving channel includes a receiving antenna, a low-noise amplifier, a frequency mixer, a narrowband analog baseband, and a low-speed analog-digital converter, wherein the receiving antenna is connected to the low-noise amplifier, the frequency mixer is connected to the oscillator and the low-noise amplifier, respectively, the narrowband analog baseband is connected to the frequency mixer, and the low-speed analog-digital converter is connected to the narrowband analog baseband and the digital signal processor, respectively.

In the existing automobile radars, the signal modulator and the oscillator generate the frequency-modulated continuous wave signal, and the oscillator transmits the frequency-modulated continuous wave signal to the power amplifier. The power amplifier amplifies the power of the frequency-modulated continuous wave signal to a preset power, and sends the amplified frequency-modulated continuous wave signal to the transmitting antenna. The transmitting antenna transmits the amplified frequency-modulated continuous wave signal at a preset time point.

After the frequency-modulated continuous wave signal encounters an obstacle, the frequency-modulated continuous wave signal is transmitted back. The receiving antenna receives the reflected frequency-modulated continuous wave signal, and there is a certain time delay between the reflected frequency-modulated continuous wave signal and the frequency-modulated continuous wave signal transmitted by the transmitting channel.

Moreover, the low-noise amplifier amplifies the frequency-modulated continuous wave signal reflected back, and then the frequency mixer performs frequency mixing on the local oscillator signal and the signal sent by the low-noise amplifier to obtain an intermediate frequency signal.

Then, the narrowband analog baseband filters and amplifies the intermediate frequency signal, and sends the filtered and amplified intermediate frequency signal to the low-speed analog-digital converter. The low-speed analog-digital converter converts the filtered and amplified intermediate frequency signal into a digital signal, and sends the digital signal to the digital signal processor.

Besides, as the M transmitting channels in FIG. 1 are turned on sequentially according to time, the digital signal processor can easily correspond the intermediate frequency signal to the transmitting channel. Therefore, the digital signal processor can analyze the digital signal to determine the information about the obstacle, wherein the information about the obstacle may include information such as position and direction of the obstacle.

In addition, as the N transmitting channels transmit the frequency-modulated continuous wave signals sequentially at different time, M time periods need to be consumed by the digital signal processor to receive the signals, and N signals are obtained in each time period, that is, the data signal processor receives N*M signals in total in the M time periods, so that N*M MIMO (Multiple-Input Multiple-Output) arrays can be virtualized.

Besides, in addition to the time division multiplexing manner described above, the M transmitting channels in the existing radars further can adopt a binary phase modulation (BPM for short) mode to transmit the frequency-modulated continuous wave signals.

It should be understood that for the binary phase modulation mode, because phase change of individual transmitting channels can be predicted, the digital signal processor can obtain the intermediate frequency signal corresponding to each transmitting channel, so that the information about the obstacle also can be obtained.

In addition, in order to realize the automatic driving of the mobile tools, it is necessary to ensure that the resolution of the radar can meet preset requirement. Moreover, in order to meet the preset requirement, the number of virtual channels of the system will be very large. For example, in the case that the preset requirement is that angular resolution of the radar can be 1° or lower, and even close to the angular resolution 0.2° of a laser radar, the number of virtual channels of the system will exceed 1000.

Furthermore, in the case that the number of virtual channels of the system is very large, as a large number of transmitting channels (for example, 20 or more) are required to virtualize such a large array, the MIMO array here will be much larger than the conventional radar.

However, regardless of the time division multiplexing mode or the binary phase modulation mode, a predetermined number of (for example, 20 or more) Chirp signals are required to transmit one MIMO sub-frame, the time of one Chirp signal is usually designed at 20 microseconds to hundreds of microseconds, and the time of a single MIMO sub-frame is up to hundreds of microseconds or even tens of milliseconds, and during the process of one MIMO sub-frame, the movement of the object under test may have exceeded one cell of resolution of the system. Therefore, the existing radars cannot detect objects moving at a high speed, which also means that the existing radars fail in the scene of automatic driving of the mobile tools.

It should be understood that the Chirp signal is a spread spectrum signal, and shows a characteristic of linear frequency modulation, and the signal frequency changes linearly over time, and is also called a linear frequency sweep signal.

Based on this, an embodiment of the present disclosure ingeniously provides a multi-input multi-output radar, wherein each transmitting channel of M transmitting channels is configured to simultaneously and respectively transmit frequency-modulated continuous wave signals of different frequencies, the frequency-modulated continuous wave signals reflected by an object to be detected are converted into digital signals through a signal demodulator in each receiving channel, and the digital signal processor parses the digital signal, so as to determine the information about the object to be detected. Thus, the frequency-modulated continuous wave signals of different frequencies are simultaneously transmitted through the plurality of transmitting channels in the embodiments of the present disclosure, and since extra time is not needed, the movement distance of the object to be detected is very small, such that the radar can detect an object moving at a high speed, and the requirements of a user are met.

In order to facilitate understanding of the embodiments of the present disclosure, some terms in the embodiments of the present disclosure are firstly explained herein as follows.

The “narrowband analog baseband” refers to an analog baseband with a signal bandwidth less than 50 MHz.

The “broadband analog baseband” refers to an analog baseband with a signal bandwidth greater than 50 MHz, generally with the bandwidth up to 1 GHz or more.

The “low-speed analog-digital converter” refers to an analog-digital converter with a signal bandwidth less than 50 MHz.

The “high-speed analog-digital converter” refers to an analog-digital converter with a signal bandwidth greater than 50 MHz, generally with the signal bandwidth up to 1 GHz or more.

It should be noted that a specific structure or configuration of the signal demodulator in the embodiments of the present disclosure may be set according to an actual requirement, as long as it is ensured that the signal demodulator can convert the frequency-modulated continuous wave signal reflected by the object to be detected into the digital signal, and the embodiments of the present disclosure are not limited thereto.

In order to facilitate understanding of the embodiments of the present disclosure, the following description is made by describing radars including different signal demodulators.

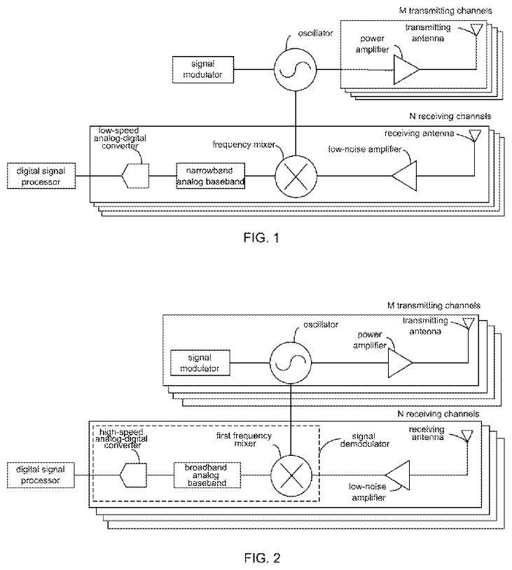

Optionally, as shown in FIG. 2, FIG. 2 shows a structural schematic view of a multi-input multi-output radar provided in an embodiment of the present disclosure. The multi-input multi-output radar as shown in FIG. 2 includes: a transmitting array composed of M transmitting channels, a receiving array composed of N receiving channels, and a digital signal processor, where M and N are both positive integers.

It should be understood that the number of transmitting channels, the number of receiving channels, and the number of digital signal processors may all be set according to actual requirements, and the embodiments of the present disclosure are not limited thereto.

For example, the number of digital signal processors may be one or two, and so on.

It should be noted that overlapping blocks in FIG. 2 indicate that the structures are the same (for example, each block in the overlapping blocks corresponding to the M transmitting channels indicates one transmitting channel), that is, the structure of each transmitting channel in the M transmitting channels in FIG. 2 is the same, and the structure of each receiving channel of the N receiving channels in FIG. 2 is also the same.

For example, the structure of M−1-th transmitting channel from top to bottom in the transmitting array is the same as that of the uppermost transmitting channel. For another example, the structure of M−2-th receiving channel from top to bottom in the receiving array is the same as that of the uppermost receiving channel.

In order to facilitate understanding of the embodiments of the present disclosure, the description is made below with one digital signal processor. It should be understood that in the case that there are a plurality of digital signal processors, those skilled in the art could make corresponding improvements or modifications, and the embodiments of the present disclosure are not limited thereto.

In the above, each transmitting channel of the M transmitting channels includes: a signal modulator, an oscillator, a power amplifier, and a transmitting antenna. In the above, the oscillator is respectively connected to a signal modulator and a power amplifier, and the transmitting antenna is connected to the power amplifier.

Moreover, each receiving channel of the N receiving channels includes: a receiving antenna, a signal demodulator, and a low-noise amplifier, and the signal demodulator includes: a first frequency mixer, a broadband analog baseband, and a high-speed analog-digital converter. In the above, the low-noise amplifier is respectively connected to the receiving antenna and the first frequency mixer, the first frequency mixer is connected to the broadband analog baseband, and the broadband analog baseband is connected to the high-speed analog-digital converter. Moreover, the digital signal processor is respectively connected to the high-speed analog-digital converter in each receiving channel.

In an embodiment of the present disclosure, M groups of signal modulators and oscillators in the M transmitting channels are configured to generate M groups of frequency-modulated continuous wave signals [f_{JL}:f_{JH}] of different frequencies (or frequency bands). In the above, J is an identifier indicating a transmitting channel, and a value of J can be any positive integer from 1 to M; f_{JL} is a lower frequency limit of the frequency band; and f_{JH} is an upper frequency limit of the frequency band.

It should be understood that the frequency bands corresponding to the frequency-modulated continuous wave signals transmitted by each transmitting channel may be set according to actual requirements, and the embodiments of the present disclosure are not limited thereto.

For example, two frequency bands corresponding to two frequency-modulated continuous wave signals may be two overlapping frequency bands, and also may be two non-overlapping frequency bands. For another example, the frequency band widths of any two frequency bands in the M frequency bands corresponding to the M frequency-modulated continuous wave signals may be the same, and also may be different.

In other words, each signal modulator in the M transmitting channels is configured to generate a modulating signal of a preset frequency (or, a different frequency), and the oscillator is configured to generate a repeated modulating signal, so as to generate the frequency-modulated continuous wave signal. In the above, the preset frequency may be any frequency, and any frequency may be any frequency in all frequencies corresponding to all frequency-modulated continuous wave signals transmitted by the M transmitting channels.

It should be understood that a preset frequency corresponding to the M transmitting channels can be set according to actual requirements, and the embodiments of the present disclosure are not limited thereto.

Subsequently, the M oscillators send the corresponding frequency-modulated continuous wave signals to the corresponding power amplifiers. Moreover, each power amplifier can amplify the corresponding frequency-modulated continuous wave signal, i.e., amplify the power of the corresponding frequency-modulated continuous wave signal to a preset power, and send the amplified frequency-modulated continuous wave signal to the transmitting antenna.

It should be understood that the amplified preset power also may be set according to an actual requirement, and the embodiments of the present disclosure are not limited thereto.

Subsequently, the M transmitting antennas simultaneously transmit corresponding amplified frequency-modulated continuous wave signals, and the frequency corresponding to each amplified frequency-modulated continuous wave signal is different.

It should be understood that the frequency-modulated continuous wave signals transmitted by the M transmitting antennas have the same transmission direction, but each transmitting antenna has a different position.

In the case that the transmitted frequency-modulated continuous wave signals encounter an object to be detected, the frequency-modulated continuous wave signals will be reflected back. Definitely, in the case that the transmitted frequency-modulated continuous wave signals do not encounter the object to be detected, the frequency-modulated continuous wave signals will not be reflected back.

It should be understood that the object to be detected may be a stationary obstacle (for example, a tree, a roadblock), and also may be a mobile obstacle (for example, a vehicle), and the embodiments of the present disclosure are not limited thereto.

Moreover, each receiving antenna in the N receiving channels can receive the frequency-modulated continuous wave signals reflected back, i.e., as the M transmitting antennas have the same transmission angle, in the case that there is an obstacle, each receiving antenna can receive the M frequency-modulated continuous wave signals reflected back at one time point.

Subsequently, each low-noise amplifier in the N receiving channels is configured to perform low-noise amplification processing on the frequency-modulated continuous wave signals reflected back (in other words, each low-noise amplifier in the N receiving channels is configured to amplify the frequency-modulated continuous wave signals reflected back), and send the low-noise-amplified frequency-modulated continuous wave signals to the first frequency mixer.

Subsequently, the first frequency mixer can perform frequency mixing on the first local oscillator signal and the low-noise-amplified frequency-modulated continuous wave signal, so as to obtain an intermediate frequency signal. In the above, the first local oscillator signal is a frequency-modulated continuous wave signal corresponding to a first preset frequency of different frequencies (frequencies corresponding to the M transmitting channels).

It should be understood that the intermediate frequency signal further may be referred to as a difference frequency signal between the first local oscillator signal and the low-noise-amplified frequency-modulated continuous wave signal, and the embodiments of the present disclosure are not limited thereto.

It should also be understood that the first local oscillator (local oscillation) signal may be set according to an actual requirement, as long as it is ensured that the first local oscillator signal is the frequency-modulated continuous wave signal corresponding to the first preset frequency in all frequencies, wherein all frequencies refer to all frequencies corresponding to all frequency-modulated continuous wave signals transmitted by the M transmitting channels, and the embodiments of the present disclosure are not limited thereto.

For example, the first local oscillator signal may be a frequency-modulated continuous wave signal corresponding to a maximum frequency band in the M groups of frequency-modulated continuous wave signals [f_{JL}:f_{JH}] of different frequency bands.

For another example, the first local oscillator signal may be a frequency-modulated continuous wave signal corresponding to the minimum frequency band in the M groups of frequency-modulated continuous wave signals [f_{JL}:f_{JH}] of different frequency bands, so that each first frequency mixer performs frequency mixing on the M low-noise-amplified frequency-modulated continuous wave signals to obtain an intermediate frequency signal f_{IF}, f_{IF}+Δf, . . . f_{IF}+(m−1)·Δf, where f_{IF} is an intermediate frequency signal corresponding to a frequency-modulated continuous wave signal received from a transmitting channel 1, and Δf is a frequency difference between adjacent frequency bands.

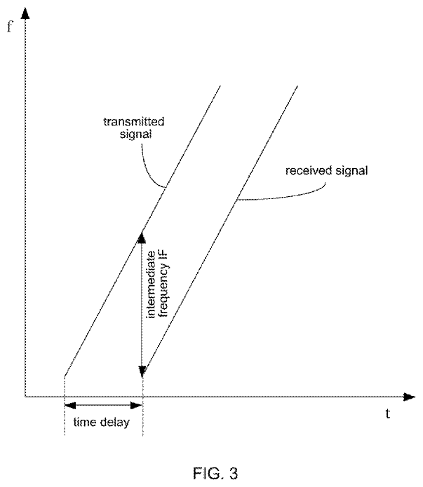

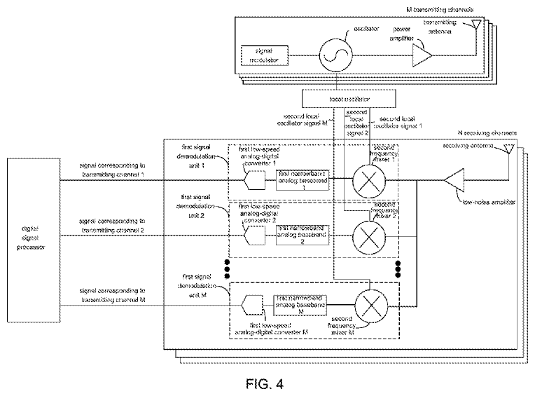

In order to facilitate understanding of the signal f_{IF}, the description is made below in combination with FIG. 3.

As shown in FIG. 3, FIG. 3 is a schematic diagram showing variation of the frequency-modulated continuous wave signal over time provided in an embodiment of the present disclosure, where the abscissa represents time t, and the ordinate represents frequency f. As the oscillator sends the transmitted signal to the local oscillator after the transmitted signal (or referred to as a transmitted frequency-modulated continuous wave signal) is transmitted, actually, the transmitted signal and the local oscillator signal are substantially consistent, but the received signal (or referred to as a reflected frequency-modulated continuous wave signal) is received after a certain time delay. There is a frequency difference between the received signal and the transmitted signal herein, and they are a fixed intermediate frequency IF, therefore, the frequency difference between the transmitted signal and the received signal at each time point is a fixed intermediate frequency IF.

It should be noted that as the first local oscillator signals corresponding to the N first frequency mixers in each receiving channel are the same, each first frequency mixer in the N first frequency mixers can be connected to the oscillator in one transmitting channel, and can also be connected to the oscillator in any transmitting channel, as long as it is ensured that the first local oscillator signals received by the N first frequency mixers are the same, and the embodiments of the present disclosure are not limited thereto.

Subsequently, each broadband analog baseband filters and amplifies the intermediate frequency signal output by the first frequency mixer, and transmits the filtered and amplified intermediate frequency signal to a corresponding high-speed analog-digital converter.

It should be understood that the filtered and amplified intermediate frequency signal also may be referred to as a baseband signal, and the embodiments of the present disclosure are not limited thereto.

Subsequently, each high-speed analog-digital converter performs analog-digital conversion on the filtered and amplified intermediate frequency signal sent by the broadband analog baseband, and sends the obtained digital signal to the digital signal processor.

Subsequently, the digital signal processor may parse the digital signals sent by all receiving channels, so as to determine information about the object to be detected.

It should be understood that the information about the object to be detected may be a position of the object to be detected, a speed of the object to be detected, or a distance from a current mobile tool to the object to be detected. That is to say, the information about the object to be detected may be set according to actual requirements, and the embodiments of the present disclosure are not limited thereto.

It also should be understood that the manner that the digital signal processor parses the digital signal so as to determine the information about the object to be detected also may be set according to actual requirements, and the embodiments of the present disclosure are not limited thereto.

For example, the digital signal processor may determine the information about the object to be detected by the phase difference reflected by the received frequency-modulated continuous wave signals of all receiving channels. In the above, as the positions of the M transmitting antennas are different, the signals obtained by reflecting the frequency-modulated continuous wave signals sent by different transmitting antennas by the same object to be detected have different phases, that is, have a phase difference.

Besides, as the M transmitting channels transmit the frequency-modulated continuous wave signals simultaneously, and the digital signal sent by each receiving channel to the digital signal processor carries signals corresponding to the M frequency-modulated continuous wave signals, the digital signal processor can receive N*M signals at one time point, that is, N*M MIMO arrays can be virtualized.

It should be noted that the multi-input multi-output radar as shown in FIG. 2 is merely exemplary, and the multi-input multi-output radar further may include more or less components than those shown in FIG. 2, and the embodiments of the present disclosure are not limited thereto.

For example, the multi-input multi-output radar as shown in FIG. 2 further may include a controller or the like.

Optionally, as shown in FIG. 4, FIG. 4 shows a structural schematic view of another multi-input multi-output radar provided in an embodiment of the present disclosure. The multi-input multi-output radar as shown in FIG. 4 includes: a transmitting array composed of M transmitting channels, a receiving array composed of N receiving channels, a local oscillator, and a digital signal processor, where M and N are both positive integers.

It should be understood that the number of local oscillators, the number of transmitting channels, the number of receiving channels, and the number of digital signal processors may all be set according to actual requirements, and the embodiments of the present disclosure are not limited thereto.

For example, the number of digital signal processors may be one or two, and so on.

It also should be understood that a manner of connecting the local oscillators and other components also may be set according to actual requirements, as long as each second frequency mixer can acquire a corresponding second local oscillator signal, and the embodiments of the present disclosure are not limited thereto.

It should be noted that overlapping blocks in FIG. 4 indicate that the structures are the same (for example, each block in the overlapping blocks corresponding to the N receiving channels indicates one receiving channel), that is, the structure of each transmitting channel is the same, and the structure of each receiving channel is also the same.

For example, the structure of M−2-th transmitting channel from top to bottom in the transmitting array is the same as that of the uppermost transmitting channel. For another example, the structure of M−3-th receiving channel from top to bottom in the receiving array is the same as that of the uppermost receiving channel.

In order to facilitate understanding of the embodiments of the present disclosure, the following description is made with one digital signal processor. It should be understood that in the case that there are a plurality of digital signal processors, those skilled in the art could make corresponding improvements or modifications, and the embodiments of the present disclosure are not limited thereto.

In the above, each transmitting channel of the M transmitting channels includes: a signal modulator, an oscillator, a power amplifier, and a transmitting antenna. In the above, the oscillator is respectively connected to the signal modulator, the power amplifier, and the local oscillator, and the transmitting antenna is connected to the power amplifier.

Moreover, each receiving channel of the N receiving channels includes: a receiving antenna, a signal demodulator, and a low-noise amplifier, the signal demodulator includes M first signal demodulation units (a first signal demodulation unit 1 to a first signal demodulation unit M) connected in parallel, and each first signal demodulation unit includes: a second frequency mixer, a first narrowband analog baseband, and a first low-speed analog-digital converter. In the above, the low-noise amplifier may be respectively connected to a receiving antenna and M second frequency mixers (a second frequency mixer 1 to a second frequency mixer M), each second frequency mixer of the M second frequency mixers is connected to a corresponding first narrowband analog baseband (for example, the second frequency mixer 1 is connected to the first narrowband analog baseband 1, etc.), and each first narrowband analog baseband is connected to a corresponding first low-speed analog-digital converter (e.g., the first narrowband analog baseband M is connected to the first low-speed analog-digital converter M, etc.).

Moreover, the digital signal processor is respectively connected to all the first low-speed analog-digital converters in the N receiving channels.

In an embodiment of the present disclosure, M groups of signal modulators and oscillators in the M transmitting channels are configured to generate M groups of frequency-modulated continuous wave signals [f_{JL}:f_{JH}] of different frequencies (or frequency bands). In the above, J is an identifier indicating a transmitting channel, and a value of J can be any positive integer from 1 to M; f_{JL} is a lower frequency limit of the frequency band; and f_{JH} is an upper frequency limit of the frequency band.

Subsequently, the M oscillators send the corresponding frequency-modulated continuous wave signals to the corresponding power amplifiers. Moreover, each power amplifier can amplify the corresponding frequency-modulated continuous wave signal, and send the amplified frequency-modulated continuous wave signal to the transmitting antenna. Subsequently, the M transmitting antennas simultaneously transmit corresponding amplified frequency-modulated continuous wave signals, and the frequency corresponding to each amplified frequency-modulated continuous wave signal is different.

It should be understood that the generation and transmission process of the frequency-modulated continuous wave signal corresponding to each transmitting channel in FIG. 4 are similar to the generation and transmission process of the frequency-modulated continuous wave signal in FIG. 2. Specifically, reference can be made to the relevant description of FIG. 2 in the preceding, and the description is not repeated herein.

In the case that the transmitted frequency-modulated continuous wave signals encounter an object to be detected, the frequency-modulated continuous wave signals will be reflected back. Definitely, in the case that the transmitted frequency-modulated continuous wave signals do not encounter the object to be detected, the frequency-modulated continuous wave signals will not be reflected back.

Moreover, each receiving antenna in the N receiving channels can receive the frequency-modulated continuous wave signals reflected back, i.e., as the M transmitting antennas have the same transmission angle, in the case that there is an object to be detected, each receiving antenna can receive the M frequency-modulated continuous wave signals reflected back at one time point.

Subsequently, each low-noise amplifier in the N receiving channels is configured to perform low-noise amplification processing on the corresponding frequency-modulated continuous wave signals reflected back, and send the low-noise-amplified frequency-modulated continuous wave signals to the corresponding M second frequency mixers.

It should be noted that the processing procedures of the M first signal demodulation units (a first signal demodulation unit 1 to a first signal demodulation unit M) in one receiving channel are similar, but they are different in that each first signal demodulation unit is configured to convert a reflected frequency-modulated continuous wave signal into a digital signal of a corresponding transmitting channel, and the embodiments of the present disclosure are not limited thereto.

For example, the first signal demodulation unit 1 is configured to convert the reflected frequency-modulated continuous wave signal into a digital signal of the corresponding transmitting channel 1. For another example, the first signal demodulation unit M is configured to convert the reflected frequency-modulated continuous wave signal into a digital signal of a corresponding transmitting channel M.

For another example, for the uppermost receiving channel shown in FIG. 4, the second local oscillator signal corresponding to each second frequency mixer in the M first signal demodulation units is different, wherein the second local oscillator signal corresponding to a second frequency mixer J is a frequency-modulated continuous wave signal [f_{JL}:f_{JH}], that is, the second local oscillator signal corresponding to each second frequency mixer is a frequency-modulated continuous wave signal of a corresponding transmitting channel, and J is any value from 1 to M (including 1 and M). That is to say, the second local oscillator signal is a frequency-modulated continuous wave signal corresponding to a second preset frequency of different frequencies.

In addition, as the transmitting channel corresponding to each first signal demodulation unit also may be changed, the second local oscillator signal may be a frequency-modulated continuous wave signal corresponding to the second preset frequency of all frequencies, that is, the second preset frequency corresponding to each first signal demodulation unit also may be changed.

For another example, for the uppermost receiving channel shown in FIG. 4, the M first signal demodulation units from top to bottom sequentially correspond to the digital signal of the transmitting channel 1 to the digital signal of the transmitting channel M.

In order to facilitate understanding of the present disclosure, the process of the first signal demodulation unit J is described below, wherein J is any value from 1 to M. It should be understood that for the implementation process of the remaining M−1 first signal demodulation units, reference can be made to relevant content of the first signal demodulation unit J in the following, and the embodiments of the present disclosure are not limited thereto.

The second frequency mixer J performs frequency mixing on the corresponding second local oscillator signal and the low-noise-amplified frequency-modulated continuous wave signal, so as to obtain an intermediate frequency signal.

Subsequently, the first narrowband analog baseband J filters and amplifies the intermediate frequency signal transmitted by the corresponding second frequency mixer J, and transmits the filtered and amplified intermediate frequency signal to the corresponding first low-speed analog-digital converter. In the above, each second frequency mixer is corresponding to one first narrowband analog baseband (for example, the second frequency mixer M is corresponding to a first narrowband analog baseband M).

It should be understood that the filtered and amplified intermediate frequency signal also may be referred to as a baseband signal, and the embodiments of the present disclosure are not limited thereto.

Subsequently, the first low-speed analog-digital converter J performs analog-digital conversion on the filtered and amplified intermediate frequency signal sent by the corresponding first narrowband analog baseband J, and sends the obtained digital signal to the digital signal processor.

Besides, the first signal demodulation unit 1 is corresponding to the signal of the transmitting channel 1, and correspondingly, the first signal demodulation unit 2 is corresponding to the signal of the transmitting channel 2. That is to say, each first signal demodulation unit is corresponding to a signal of one transmitting channel.

Subsequently, the digital signal processor may parse the digital signals sent by all receiving channels, so as to determine information about the object to be detected.

It also should be understood that the manner that the digital signal processor parses the digital signals sent by all receiving channels so as to determine the information about the object to be detected also may be set according to actual requirements, and the embodiments of the present disclosure are not limited thereto.

It should be noted that the multi-input multi-output radar as shown in FIG. 4 is merely exemplary, and the multi-input multi-output radar may include more or less components than those shown in FIG. 4, and the embodiments of the present disclosure are not limited thereto.

For example, the multi-input multi-output radar as shown in FIG. 4 further may include a controller.

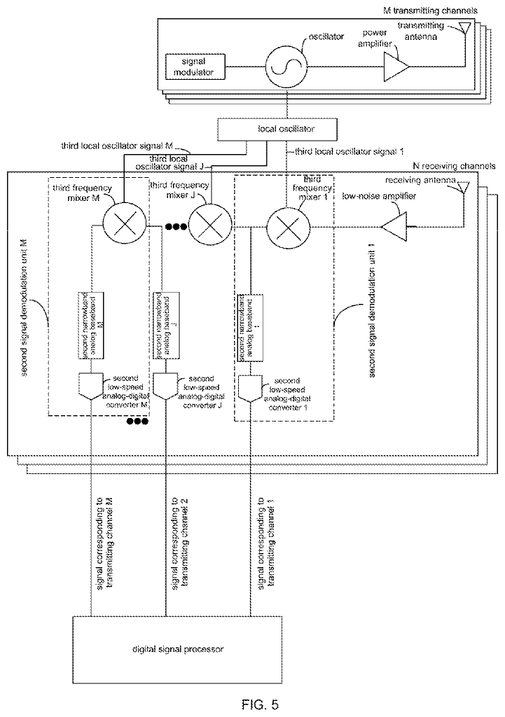

Optionally, as shown in FIG. 5, FIG. 5 shows a structural schematic view of another multi-input multi-output radar provided in an embodiment of the present disclosure. The multi-input multi-output radar as shown in FIG. 5 includes: a transmitting array composed of M transmitting channels, a receiving array composed of N receiving channels, a local oscillator, and a digital signal processor, where M and N are both positive integers.

It should be understood that the number of local oscillators, the number of transmitting channels, the number of receiving channels, and the number of digital signal processors may all be set according to actual requirements, and the embodiments of the present disclosure are not limited thereto.

For example, the number of digital signal processors may be one or two, and so on.

It also should be understood that a manner of connecting the local oscillators and other components (for example, a third frequency mixer 1 and so on) also may be set according to actual requirements, and the embodiments of the present disclosure are not limited thereto.

It should be noted that overlapping blocks in FIG. 5 indicate that the structures are the same (for example, each block in the overlapping blocks corresponding to the M transmitting channels indicates one transmitting channel), that is, the structure of each transmitting channel is the same, and the structure of each receiving channel is the same.

For example, the structure of the M−2-th transmitting channel from top to bottom in the transmitting array is the same as that of the uppermost transmitting channel. For another example, the structure of the M−1-th receiving channel from top to bottom in the receiving array is the same as that of the uppermost receiving channel.

In order to facilitate understanding of the embodiments of the present disclosure, the description is made below with one digital signal processor. It should be understood that in the case that there are a plurality of digital signal processors, those skilled in the art could make corresponding improvements or modifications, and the embodiments of the present disclosure are not limited thereto.

In the above, each transmitting channel of the M transmitting channels includes: a signal modulator, an oscillator, a power amplifier, and a transmitting antenna. In the above, the oscillator is respectively connected to the signal modulator, the power amplifier, and the local oscillator, and the transmitting antenna is connected to the power amplifier.

It should be understood that a manner of connecting the local oscillators and other components also may be set according to actual requirements, as long as each third frequency mixer can acquire a corresponding third local oscillator signal, and the embodiments of the present disclosure are not limited thereto.

Moreover, each receiving channel of the N receiving channels includes: a receiving antenna, a signal demodulator, and a low-noise amplifier, the signal demodulator includes M second signal demodulation units (a second signal demodulation unit 1 to a second signal demodulation unit M) connected in series, and each second signal demodulation unit includes a third frequency mixer, a second narrowband analog baseband, and a second low-speed analog-digital converter. In the above, the second signal demodulation units connected in series each are configured to convert the reflected frequency-modulated continuous wave signal into a digital signal of corresponding transmitting channel.

In the above, the low-noise amplifier is respectively connected to a receiving antenna and a third frequency mixer 1 in the second signal demodulation unit 1, and the third frequency mixer 1 in the second signal demodulation unit 1 is further connected to a third frequency mixer 2 in the second signal demodulation unit 2 and the second narrowband analog baseband 1 in the second signal demodulation unit 1, and the second narrowband analog baseband 1 in the second signal demodulation unit 1 is further connected to the second low-speed analog-digital converter 1 in the second signal demodulation unit 1.

Moreover, the third frequency mixer 2 in the second signal demodulation unit 2 is further connected to a third frequency mixer 3 in the second signal demodulation unit 3 and the second narrowband analog baseband 2 in the second signal demodulation unit 2, and the second narrowband analog baseband 2 in the second signal demodulation unit 2 is further connected to the second low-speed analog-digital converter 2 in the second signal demodulation unit 2.

It should be understood that a connection manner and a structure of the remaining second signal demodulation units (for example, a second signal demodulation unit J, where J may be any value from 1 to M, and include the value M and so on) may be similar to the structure of the second signal demodulation unit 2, and are not further described in the following. Specifically, reference can be made to relevant description of the second signal demodulation unit 2.

In an embodiment of the present disclosure, M groups of signal modulators and oscillators in the M transmitting channels are configured to generate M groups of frequency-modulated continuous wave signals [f_{JL}:f_{JH}] of different frequencies (or frequency bands). Subsequently, the M oscillators send the corresponding frequency-modulated continuous wave signals to the corresponding power amplifiers. Moreover, each power amplifier can amplify the corresponding frequency-modulated continuous wave signal, and send the amplified frequency-modulated continuous wave signal to the transmitting antenna. Subsequently, the M transmitting antennas simultaneously transmit corresponding amplified frequency-modulated continuous wave signals, and the frequency corresponding to each amplified frequency-modulated continuous wave signal is different.

Besides, the oscillator further sends the frequency-modulated continuous wave signal to the local oscillator, so that the local oscillator sends a third local oscillator signal to different second signal demodulation units.

It should be understood that the generation and transmission process of the frequency-modulated continuous wave signals corresponding to each transmitting channel in FIG. 5 are similar to the generation and transmission process of the frequency-modulated continuous wave signals in FIG. 2. Specifically, reference can be made to the relevant description of FIG. 2 in the preceding, and the description is not repeated herein.

In the case that the transmitted frequency-modulated continuous wave signals encounter an object to be detected, the frequency-modulated continuous wave signals will be reflected back. Definitely, in the case that the transmitted frequency-modulated continuous wave signals do not encounter the object to be detected, the frequency-modulated continuous wave signals will not be reflected back.

Moreover, each receiving antenna in the N receiving channels can receive the frequency-modulated continuous wave signals reflected back, i.e., as the M transmitting antennas have the same transmission angle, in the case that there is an object to be detected, each receiving antenna can receive the M frequency-modulated continuous wave signals reflected back at one time point.

Subsequently, each low-noise amplifier in the N receiving channels performs low-noise amplification processing on the frequency-modulated continuous wave signals reflected back, and sends the low-noise-amplified frequency-modulated continuous wave signals to the third frequency mixer 1 in the second signal demodulation unit 1.

Subsequently, the third frequency mixer 1 in the second signal demodulation unit 1 performs frequency mixing on a third local oscillator signal 1 and the low-noise-amplified frequency-modulated continuous wave signal, wherein the third local oscillator signal 1 is a frequency-modulated continuous wave signal [f_{1L}:f_{1H}] corresponding to the transmitting channel 1. Moreover, as a certain time delay exists between the reflected frequency-modulated continuous wave signal and the transmitted frequency-modulated continuous wave signal, an output signal of the third frequency mixer 1 in the second signal demodulation unit 1 is f_{IF}, f_{IF}+Δf, . . . , f_{IF}+(M−1)·Δf.

The second narrowband analog baseband unit 1 in the second signal demodulation unit 1 filters and amplifies the signal output by the third frequency mixer 1 and takes the signal f_{IF} corresponding to the transmitting channel 1. Subsequently, the second low-speed analog-digital converter 1 in the second signal demodulation unit 1 converts the signal f_{IF} corresponding to the transmitting channel 1 into a corresponding digital signal, and sends the converted digital signal to the digital signal processor.

Moreover, the third frequency mixer 2 of the second signal demodulation unit 2 performs frequency mixing on a third local oscillator signal 2 and an output signal after passing through the third frequency mixer 1 in the second signal demodulation unit 1, wherein the third local oscillator signal 2 is a signal Δf, where Δf is a frequency difference between adjacent frequency bands.

It should be noted that the frequency difference between adjacent frequency bands may be set according to actual requirements, and the embodiments of the present disclosure are not limited thereto.

For example, in the case that the frequency band difference between any two adjacent frequency bands is a fixed frequency band difference, Δf is the fixed frequency band difference.

For another example, in the case that the frequency band differences between any two adjacent frequency bands are unequal frequency band differences, Δf may be any one of M−1 unequal frequency band differences.

The signals output by the third frequency mixer 2 in the second signal demodulation unit 2 are Δf−f_{IF}, f_{IF}, f_{IF}+Δf, . . . , f_{IF}+(M−2)·Δf. The second narrowband analog baseband 2 in the second signal demodulation unit 2 filters and amplifies the signal output by the third frequency mixer 2 and takes the signal f_{IF} corresponding to the transmitting channel 2. Subsequently, the second low-speed analog-digital converter 2 in the second signal demodulation unit 2 converts the signal f_{IF} corresponding to the transmitting channel 2 into a corresponding digital signal, and sends the converted digital signal to the digital signal processor.

It should be understood that the third local oscillator signal J of the remaining second signal demodulation unit J is (M−1)·Δf, and the output signal after undergoing frequency mixing by the third frequency mixer J in the second signal demodulation unit J is (M−1)·Δf, . . . , Δf−f_{IF}, f_{IF}. Moreover, the second narrowband analog baseband J in the second signal demodulation unit J filters and amplifies the output signal after undergoing frequency mixing by the third frequency mixer J and takes the signal f_{IF} corresponding to the transmitting channel J. Subsequently, the second low-speed analog-digital converter J in the second signal demodulation unit J converts the signal f_{IF} corresponding to the transmitting channel J into a corresponding digital signal, and sends the converted digital signal to the digital signal processor. In the above, J is a positive integer greater than or equal to 2 and less than or equal to M.

Besides, the second signal demodulation unit 1 is corresponding to the signal of the transmitting channel 1, and correspondingly, the second signal demodulation unit 2 is corresponding to the signal of the transmitting channel 2. That is to say, one second signal demodulation unit is corresponding to the signal of one transmitting channel.

Subsequently, the digital signal processor may parse the digital signals sent by all receiving channels, so as to determine information about the object to be detected.

It should be understood that the manner that the digital signal processor parses the digital signals sent by all receiving channels so as to determine the information about the object to be detected also may be set according to actual requirements, and the embodiments of the present disclosure are not limited thereto.

It should be noted that the multi-input multi-output radar as shown in FIG. 5 is merely exemplary, and the multi-input multi-output radar may include more or less components than those shown in FIG. 5, and the embodiments of the present disclosure are not limited thereto.

For example, the multi-input multi-output radar as shown in FIG. 5 further may include a controller.

It should be noted that although the M transmitting channels transmit the frequency-modulated continuous wave signals in the frequency division multiplexing manner in FIG. 2, FIG. 4, and FIG. 5, those skilled in the art further could perform the transmission of the frequency-modulated continuous wave signals in other manners, as long as it is ensured that the M transmitting channels can transmit the M frequency-modulated continuous waves at one time point, and the embodiments of the present disclosure are not limited thereto.

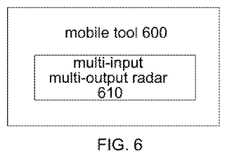

Referring to FIG. 6, FIG. 6 shows a structural schematic view of a mobile tool 600 provided in an embodiment of the present disclosure. As shown in FIG. 6, the mobile tool 600 includes: any of the multi-input multi-output radars 610 as shown in FIG. 2, FIG. 4, and FIG. 5.

It should be understood that the mobile tool can be a fuel automobile, a new energy automobile or a ship. That is to say, the mobile tool may be set according to actual requirements, and the embodiments of the present disclosure are not limited thereto.

In the several embodiments provided in the present disclosure, it should be understood that the device and the method disclosed also may be implemented in other manners. The device embodiments described above are merely illustrative, for example, the flowcharts and the block diagrams in the drawings show possible system structures, functions, and operations of the device, method, and computer program products according to multiple embodiments of the present disclosure. In this regard, each block in the flowcharts or the block diagrams may represent a module, program segment or a part of code, and the module, program segment, or the part of code contains one or more executable instructions configured to achieve a specified logical function. It also should be noted that in some embodiments as substitution, the functions indicated in the blocks also may be proceeded in an order different from that indicated in the drawings. For example, two continuous blocks practically can be executed substantially in parallel, and they sometimes also may be executed in a reverse order, which depends upon a function involved. It also should be noted that each block in the block diagrams and/or flowcharts, and combinations of the blocks in the block diagrams and/or the flowcharts can be realized by a dedicated hardware-based system configured to execute a specified function or action, or can be realized by a combination of dedicated hardware and computer instructions.

Besides, the various functional modules in various embodiments of the present disclosure can be integrated together to form one independent portion, and it is also possible that the various modules exist independently, or that two or more modules are integrated to form one independent part.

If the function is realized in a form of software functional module and is sold or used as an individual product, it may be stored in one computer readable storage medium. Based on such understanding, the technical solutions in essence or parts making contribution to the prior art or parts of the technical solutions of the present disclosure can be embodied in form of a software product, and this computer software product is stored in a storage medium, including several instructions for making one computer device (which can be a personal computer, a server or a network device, etc.) execute all or part of the steps of the methods of various embodiments of the present disclosure. The storage medium above includes various media in which program codes can be stored, such as U disk, mobile hard disk, Read-Only Memory (ROM), Random Access Memory (RAM), diskette or compact disk. It should be indicated that in the present text, relational terms such as first and second are merely for distinguishing one entity or operation from another entity or operation, while it is not required or implied that these entities or operations necessarily have any such practical relation or order. Moreover, terms “including”, “containing” or any other derivatives thereof are intended to be non-exclusive, thus a process, method, article or device including a series of elements not only includes those elements, but also includes other elements that are not listed definitely, or further includes elements inherent to such process, method, article or device. Without more restrictions, an element defined with wordings “including a . . . ” does not exclude presence of other same elements in the process, method, article or device including said element.

The above-mentioned are merely for preferred embodiments of the present disclosure and not used to limit the present disclosure. For one skilled in the art, various modifications and changes may be made to the present disclosure. Any modifications, equivalent substitutions, improvements and so on, made within the spirit and principle of the present disclosure, should be covered within the scope of protection of the present disclosure. It should be noted that similar reference signs and letters represent similar items in the following drawings, therefore, once a certain item is defined in one drawing, it is not needed to be further defined or explained in subsequent drawings.

The above-mentioned are merely specific embodiments of the present disclosure, but the scope of protection of the present disclosure is not limited thereto, and any modification or substitution that may be easily envisaged by those skilled in the present art within the technical scope disclosed in the present disclosure should fall within the scope of protection of the present disclosure. Therefore, the scope of protection of the present disclosure should be based on the scope of protection of the claims.

### INDUSTRIAL APPLICABILITY

The embodiments of the present disclosure ingeniously provide a multi-input multi-output radar, wherein each transmitting channel of the M transmitting channels is configured to simultaneously and respectively transmit the frequency-modulated continuous wave signals of different frequencies, the frequency-modulated continuous wave signals reflected by the object to be detected are converted into the digital signals through the signal demodulator in each receiving channel, and the digital signal processor parses the digital signals, so as to determine the information about the object to be detected. Thus, the frequency-modulated continuous wave signals of different frequencies are simultaneously transmitted through the multiple transmitting channels in the embodiments of the present disclosure, and since extra time is not needed, the movement distance of the object to be detected is very small, such that the radar can detect an object moving at a high speed, and the requirements of a user are met.

1. A multi-input multi-output radar, comprising a digital signal processor, M transmitting channels, and N receiving channels, wherein each transmitting channel of the M transmitting channels is configured to simultaneously and respectively transmit frequency-modulated continuous wave signals of different frequencies, each receiving channel of the N receiving channels comprises a receiving antenna and a signal demodulator, wherein M and N are both positive integers, wherein the receiving antenna is configured to receive a frequency-modulated continuous wave signal reflected by an object to be detected;
the signal demodulator is connected to the receiving antenna, and the signal demodulator is configured to convert a reflected frequency-modulated continuous wave signal into a digital signal, wherein the digital signal is used to determine information about the object to be detected; and
the digital signal processor is configured to parse the digital signal, so as to determine the information about the object to be detected.

2. The radar according to claim 1, wherein the signal demodulator comprises a first frequency mixer, a broadband analog baseband, and a high-speed analog-digital converter, wherein
the first frequency mixer is connected to the receiving antenna, the first frequency mixer is configured to perform frequency mixing on a first local oscillator signal and the reflected frequency-modulated continuous wave signal, so as to obtain a first intermediate frequency signal, wherein the first local oscillator signal is a frequency-modulated continuous wave signal corresponding to a first preset frequency in the different frequencies;
the broadband analog baseband is connected to the first frequency mixer, and the broadband analog baseband is configured to filter and amplify the first intermediate frequency signal, so as to obtain a filtered and amplified first intermediate frequency signal; and
the high-speed analog-digital converter is connected to the broadband analog baseband, and the high-speed analog-digital converter is configured to perform analog-digital conversion on the filtered and amplified first intermediate frequency signal, so as to obtain the digital signal.

3. The radar according to claim 1, wherein the signal demodulator comprises M first signal demodulation units connected in parallel, and each first signal demodulation unit of the M first signal demodulation units connected in parallel is corresponding to one transmitting channel,
wherein each first signal demodulation unit of the M first signal demodulation units connected in parallel is configured to convert the reflected frequency-modulated continuous wave signal into a digital signal of a corresponding transmitting channel.

4. The radar according to claim 3, wherein each first signal demodulation unit of the M first signal demodulation units connected in parallel comprises a second frequency mixer, a first narrowband analog baseband, and a first low-speed analog-digital converter, wherein
the second frequency mixer is connected to the receiving antenna, the second frequency mixer is configured to perform frequency mixing on a second local oscillator signal and the reflected frequency-modulated continuous wave signal, so as to obtain a second intermediate frequency signal, wherein the second local oscillator signal is a frequency-modulated continuous wave signal corresponding to a second preset frequency in the different frequencies;
the first narrowband analog baseband is connected to the second frequency mixer, and the first narrowband analog baseband is configured to filter and amplify the second intermediate frequency signal, so as to obtain a filtered and amplified second intermediate frequency signal; and
the first low-speed analog-digital converter is connected to the first narrowband analog baseband, and the first low-speed analog-digital converter is configured to perform analog-digital conversion on the filtered and amplified second intermediate frequency signal, so as to obtain the digital signal of the corresponding transmitting channel.

5. The radar according to claim 1, wherein the signal demodulator comprises M second signal demodulation units connected in series, wherein each second signal demodulation unit of the M second signal demodulation units connected in series is corresponding to one transmitting channel,
wherein each second signal demodulation unit of the M second signal demodulation units connected in series is configured to convert the reflected frequency-modulated continuous wave signal into a digital signal of a corresponding transmitting channel.

6. The radar according to claim 5, wherein each second signal demodulation unit of the M second signal demodulation units connected in series comprises a third frequency mixer, a second narrowband analog baseband, and a second low-speed analog-digital converter.

7. The radar according to claim 1, wherein each transmitting channel of the M transmitting channels comprises a signal modulator, an oscillator, and a transmitting antenna, wherein
the signal modulator is configured to generate a modulating signal of a third preset frequency, wherein the third preset frequency is any frequency in the different frequencies;
the oscillator is connected to the signal modulator, and the oscillator is configured to generate a repeated modulating signal, so as to generate the frequency-modulated continuous wave signal; and
the transmitting antenna is connected to the oscillator, and the transmitting antenna is configured to transmit the frequency-modulated continuous wave signal.

8. The radar according to claim 7, wherein each transmitting channel of the M transmitting channels further comprises a power amplifier connected to the transmitting antenna and the oscillator, respectively, wherein the power amplifier is configured to amplify the frequency-modulated continuous wave signal, and send an amplified frequency-modulated continuous wave signal to the transmitting antenna.

9. The radar according to claim 1, wherein each receiving channel of the N receiving channels further comprises a low-noise amplifier connected to the receiving antenna and the signal demodulator, respectively, wherein the low-noise amplifier is configured to perform low-noise amplification on the reflected frequency-modulated continuous wave signal, and send a low-noise-amplified frequency-modulated continuous wave signal to the signal modulator-demodulator.

10. A mobile tool, comprising the multi-input multi-output radar according to claim 1.
